(19) United States
(12) Patent Application Publication
(10) Pub. No.: US 2018/0124871 A1
(43) Pub. Date: May 3, 2018

(54) CARBON VEIL HEATER AND METHOD OF MAKING

(71) Applicant: GENTHERM GMBH, Odelzhausen (DE)

(72) Inventors: Jack Barfuss, Windsor (CA); Dmitri Kossakovski, South Pasadena, CA (US)

(21) Appl. No.: 15/471,660

(22) Filed: Mar. 28, 2017

Related U.S. Application Data
(60) Provisional application No. 62/414,970, filed on Oct. 31, 2016.

(51) Int. Cl. H05B 3/03; H05B 1/02; H05B 3/14; H05B 3/34; B32B 7/12; B32B 37/12

(52) U.S. Cl. CPC H05B 3/03; H05B 1/0238; H05B 3/145; B32B 2457/00; B32B 7/12; B32B 37/12; H05B 3/34

(57) ABSTRACT

A heater comprising: (a) a resistive substrate that produces heat upon an application of power; (b) a substrate adhesive including a portion that extends into the resistive substrate and a portion that extends from one or more sides of the resistive substrate so that one side of the resistive substrate is free of the substrate adhesive and one or more sides is covered by a layer of the substrate adhesive; (c) one or more power application portions connected to the resistive substrate on the side of the resistive substrate that is free of the substrate adhesive; (d) one or more attachment devices that connect the one or more power application portions to the resistive substrate; (e) a closing layer including: (i) a closing backing and (ii) a backing adhesive that includes a portion that extends into the closing backing and a portion that extends from one or more sides of the closing backing so that one side of the closing backing is free of the backing adhesive and one or more sides is covered by a layer of the backing adhesive; and wherein the closing layer extends over the one or more power application portions so that the backing adhesive covers the one or more power application portions, and wherein the substrate adhesive and the backing adhesive extend together to form a single layer of adhesive.

### FIELD

The present teachings generally relate to a substantially carbon heating device with a multi-layer impregnated construction, a heater with regions that are free of heating, a heater without pockets, or a combination thereof and a method of making the same.

### BACKGROUND

The present teachings are predicated upon providing an improved volumetric heater (hereinafter “heater”) and more preferably an improved heater for use in a vehicle. Generally, heaters include a wire that is formed in a pattern. The wire produces heat when electricity is applied to the wire. The wire may also be placed in a carbonaceous material so that as the wire heats up the heat is diffused into the carbonaceous material heating a larger area. However, achieving uniform heating in these devices may not always be achieved and hot spots may occur around the heating wires. Further, if a heating wire breaks the heater may cease to heat. Heaters may also include electrodes that are connected by a positive temperature coefficient material so that electricity is conducted from one electrode through the positive coefficient material to the other electrode and heat is produced. Other heaters have a woven configuration where a plurality of long materials are woven together to form a heater. These heaters may result in hot spots along one or more of the long materials as these materials may allow for current drift along one wire. Examples of heaters may be found in U.S. Pat. Nos. 5,824,996; 5,935,474; 6,057,530; 6,150,642; 6,172,344; 6,294,758; 7,053,344; 7,285,748; and 7,838,804; U.S. Patent Application Publication Nos. 2003/155347; 2004/0211772; 2007/0278210; 2009/0242548; 2010/0200558; 2010/0282458, and 2013/0186884; European Patent No. EP2400814; and Japanese Patent Publication No. JP02-120039 all of which are incorporated by reference herein for all purposes.

It would be attractive to have a high degree of flexibility to conform to an occupant and to avoid crinkling noises or the like in response to occupant motion. It would be attractive to have a robust heater that is durable and can withstand cycling without experiencing adverse effects. In this regard one attractive feature is to be free of dependency upon fluctuating prices for high demand metals such as gold, silver, copper, or the like.

What is needed is a flexible seat heater that is free of and/or substantially free of gold, silver, and copper. It would be attractive to have a heater that can be cut and pasted into shapes and configurations to heat predetermined regions and be free of heating in predetermined regions. What is needed is a seat heater that is free of a pocket and all of the electrical componentry is connected on an outside of the heater. It would be attractive to have a method of partially impregnating a resistive substrate with an adhesive.

### SUMMARY

The present teachings meet one or more (if not all) of the present needs by providing: A heater comprising: (a) a resistive substrate that produces heat upon an application of power; (b) a substrate adhesive including a portion that extends into the resistive substrate and a portion that extends from one or more sides of the resistive substrate so that one side of the resistive substrate is free of the substrate adhesive and one or more sides is covered by a layer of the substrate adhesive; (c) one or more power application portions connected to the resistive substrate on the side of the resistive substrate that is free of the substrate adhesive; (d) one or more attachment devices that connect the one or more power application portions to the resistive substrate; (e) a closing layer including: (i) a closing backing and (ii) a backing adhesive that includes a portion that extends into the closing backing and a portion that extends from one or more sides of the closing backing so that one side of the closing backing is free of the backing adhesive and one or more sides is covered by a layer of the backing adhesive; and wherein the closing layer extends over the one or more power application portions so that the backing adhesive covers the one or more power application portions, and wherein the substrate adhesive and the backing adhesive extend together to form a single layer of adhesive.

The heater of the teachings may include: a heater comprising: (a) a resistive substrate that produces heat upon an application of power; (b) one or more power application portions connected to the resistive substrate; (c) one or more attachment devices that connect the one or more power application portions to the resistive substrate; (d) a closing layer including: (i) a closing backing; (ii) a backing adhesive that extends over the one or more power application portions and connects the closing layer to the resistive substrate and the one or more power application portions; (iii) one or more holes that extend through the closing layer so that a portion of the resistive substrate is exposed through the hole; and (e) a thermistor; wherein the thermistor, the one or more power application portions, or both extend through the one or more holes in the closing layer.

The present teachings provide: heater comprising: (a) a resistive substrate that produces heat upon an application of power; (b) one or more power application portions connected to the resistive substrate; (c) one or more attachment devices that connect the one or more power application portions to the resistive substrate; (d) a closing layer including one or holes that extend through the closing layer; (e) a thermistor; and (f) a patch that extends over a portion of the closing layer and the thermistor, the patch including a patch adhesive that penetrates partially into the patch and the patch adhesive having a portion that extends around one or more sides of the patch.

The present teachings envision a process that provides: a method comprising: (a) applying a substrate adhesive to a resistive substrate that produces heat upon an application of power, and (b) preventing the substrate adhesive from fully penetrating through the resistive substrate so that the resistive substrate includes a side with the substrate adhesive and a side that is free of the substrate adhesive, (c) applying one or more power application portions over the side of the resistive substrate that is free of the substrate adhesive; (d) applying a closing layer over the one or more power application portions, the closing layer including: (i) a closing backing and (ii) a backing adhesive that includes a portion that extends into the closing backing and a portion that extends from one or more sides of the closing backing so that one side of the closing backing is free of the backing adhesive and one or more sides is covered by a layer of the backing adhesive; (e) laminating the closing layer and the resistive substrate so that the backing adhesive and the substrate adhesive connect and form one contiguous.

The teachings herein surprisingly solve one or more of these problems by providing a high degree of flexibility to conform to an occupant and to avoid crinkling noises or the like in response to occupant motion. The present teachings provide a robust heater that is durable and can withstand cycling without experiencing adverse effects. The present teachings provide a flexible seat heater that is free of and/or substantially free of gold, silver, and copper. The present teachings provide a heater that can be cut and pasted into shapes and configurations to heat predetermined regions and be free of heating in predetermined regions. The present teachings provide a seat heater that is free of a pocket and all of the electrical componentry is connected on an outside of the heater. The present teachings provide a method of partially impregnating a resistive substrate with an adhesive.

### BRIEF DESCRIPTION OF THE DRAWINGS

FIG. 1A illustrates a side view of adhesive partially impregnated into a resistive substrate;

FIG. 1B illustrates a side view of backing connected to the resistive substrate and adhesive of FIG. 1A;

FIG. 1C illustrates a side view of power application portion connected to the resistive substrate of FIG. 1B opposite the backing;

FIG. 1D illustrates the partial heaters of FIG. 1C cut into a plurality of discrete heaters;

FIG. 2 illustrates wires pulled from the power application portions of FIG. 1D;

FIG. 3 illustrates a side view of a closing layer with an adhesive partially impregnated into a resistive substrate;

FIG. 4A illustrates the closing layer of FIG. 3 placed over the partial heater of FIG. 2;

FIG. 4B illustrates a side view of the partial heater and closing layer of FIG. 4A;

FIG. 5 illustrates wires and a thermistor added to the heater of FIG. 4B;

FIG. 6 illustrates a partial exploded view of a patch removed from a heater;

FIG. 6A is a cross-sectional view of the patch and heater of FIG. 6;

FIG. 6B is a cross-sectional view of the patch of FIG. 6;

FIG. 7 is a close-up view of a wire connected to conductor;

FIG. 8A illustrates the partial heater of FIG. 1A slit into a plurality of partial heater strips;

FIG. 8B illustrates the partial heater strips of 8A connected to a backing with gaps located between the partial heater strips;

FIG. 8C illustrates the partial heater of FIG. 8B with power application portions;

FIG. 8D illustrates the partial heaters of FIG. 8C cut into separate heaters;

FIG. 8E is a top view of one partial heater of FIG. 8D including wires extending from the power application portions;

FIG. 8F illustrates a closing layer covering the partial heater of FIG. 8E;

FIG. 9A illustrates the partial heater of FIG. 10 including holes;

FIG. 9B illustrates power application portions pulled through some of the holes in FIG. 9A;

FIG. 9C illustrates a closing layer extending over the partial heater of FIG. 9B;

FIG. 9D is a back side of the partial heater of FIG. 9C with the power application portions pulled through the holes;

FIG. 9E is the heater of FIG. 9D including a thermistor and the power application portions connected to wires; and

FIG. 9F illustrates a patch extending over the thermistor and wires of FIG. 9E.

### DETAILED DESCRIPTION

The explanations and illustrations presented herein are intended to acquaint others skilled in the art with the invention, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The device as taught herein may be useful as a heater and/or incorporated into another device so that the other device may be used as a heater. The device as taught herein may be used for any known heating application. For example, the heater may be used to heat a bed, plants, be a therapeutic heater, vehicle seats, steering wheels, mirrors, glass, flooring, the like, or a combination thereof. Preferably, the device as taught herein may be connected to, incorporated into, or both a vehicle seat and/or the vehicle seat may include the composition taught herein so that a vehicle seat may be heated. The heater as discussed herein may be a discrete piece that is laid over a cushion of a vehicle seat (i.e., bun or back portion) and then a trim cover placed over the heater. The heater may be incorporated into a trim cover or part of a trim cover may form a layer of the heater. A portion of the heater may enter a trench or extend over a trench in the cushion so that the heater, the cushion, the trim cover, or a combination thereof are attached to a seat frame. The heater may be shapeable, formable, cuttable, or a combination thereof so that heater may be substantially prevented form heating the trench regions of a vehicle seat. For example, a portion of the heater may be cut out so that substantially only the electrodes, busses, power conductors, or a combination thereof extend into the trench of a vehicle seat. In another example, the resistive substrate may be cut so that the resistive substrate extends up to the trench in a central region of the heater but not into the trench and the portion of the resistive substrate proximate to the electrodes, busses, power conductors, or a combination thereof extends into and/or around the trench to provide support. The heater may be cut into a plurality of slits. A trim cover may have attachment features that extend through the heater so that the heater is connected to the trim cover and substantially extends over the trench while the attachment features act to secure both the trim cover and the heater to the seat.

The heater may be secured in the vehicle seat by a mechanical fastener, an adhesive, pressure from one or more adjacent layers, or a combination thereof. The heater may be secured directly to the trim layer, the cushion (i.e., bun, back, or both) of the seat, or a combination of both. A mechanical fastener may extend through, connect to, attach on, or a combination thereof the heater so that the heater may be fixed within the seat.

The heater may be used with or as a passenger sensor. The heater may be placed over and/or under a passenger senor. The passenger sensor may be any type of passenger sensor that senses the presence of a passenger. The passenger sensor may be a capacitive sensor, a pressure sensor, a membrane sensor, infrared, passive and/or active ultrasonic sensor, a mass sensor, or a combination thereof. The heater and a passenger sensor may be used with an active cooling system, active heating system, a ventilated system, or a combination thereof.

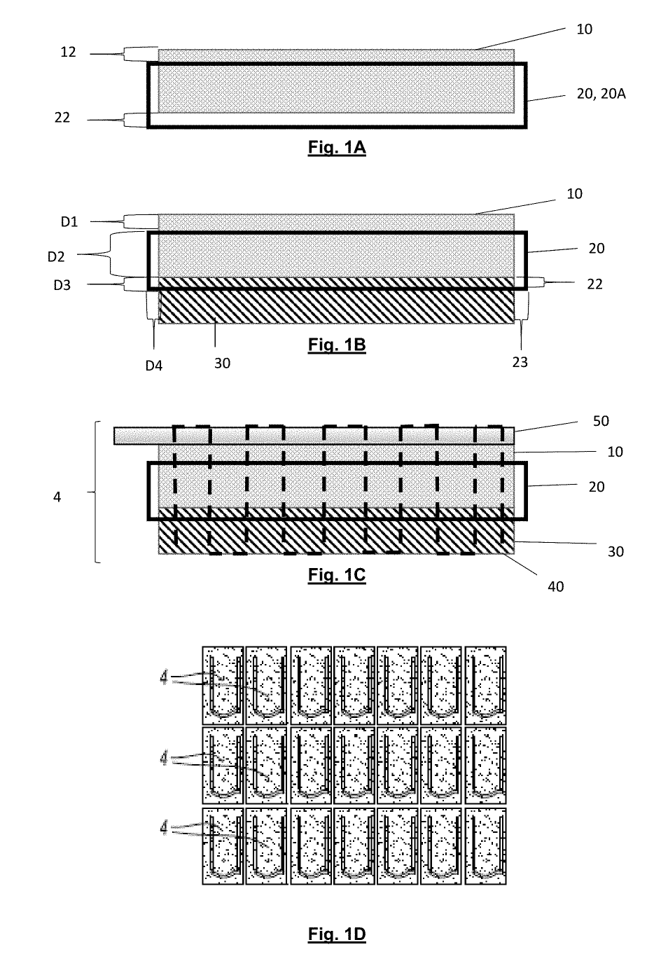

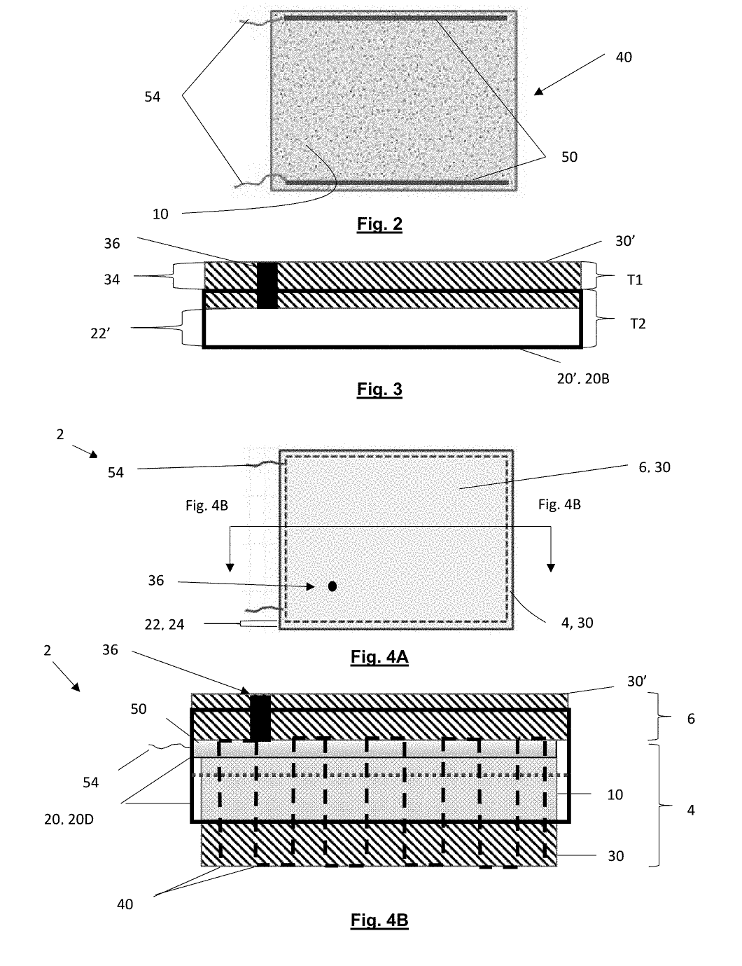

The heater may be used with an active heating, active cooling, ventilation, or a combination thereof system. The barrier layer when present may be formed in any configuration so that air may be directed to specific desired locations. For example, the heater may be substantially porous through a central “U” shaped portion of the heater and the regions surrounding the “U” shape may include a non-porous or barrier material that may prevent a fluid from passing so that the fluid moved is directed to the contact areas. The heater may include one or more through holes so that air may be moved through the heater. The heater may include and/or be in fluid communication with a fan and/or blower, be adjacent to a blower and/or fan so that the blower and/or fan may move a fluid through and/or around the heater. The heater, the fan, the blower, or a combination thereof may include a peltier device, a thermoelectric device, or both so that hot and/or cooled air (i.e., conditioned air) may be moved towards an occupant. The heater may be indirectly connected to a fan, blower, or both that include a peltier device, a thermoelectric device, or both. The heater may be connected to an insert (i.e., bag) that assists in distributing conditioned air to an occupant. The heater may have one or more holes that mirror the holes in the insert. The heater layer may be connected directly to the insert. All or a portion of the heater layer may be connected to the insert. The insert may be one or more polymeric layers that form a substantially air impermeable layer and/or an air impermeable layer so that air directed into the insert is directed to a predetermined region. The insert may include one or more spacer materials. Additional aspects of the insert and its various layers and materials can be gleaned from the teachings herein including those of Column 1, line 45 through Column 3, line 67; Column 4; line 54 though Column 6, line 32 and FIGS. 2-3 of U.S. Pat. No. 7,083,227, and Column 3; line 34 through Column 10; line 2; Column 11, line 4 through Column 13, line 18; and FIGS. 1, 4, 15A and 15B of U.S. Pat. No. 7,735,932 incorporated by reference herein, which shows various alternative embodiments of inserts, insert materials, and insert constructions that may be used with the heater taught herein. The heater as taught herein includes a resistive substrate (i.e., heating layer).

The resistive substrate may be formed as a sheet. Preferably, the resistive substrate as taught herein is a nonwoven sheet. For example, the resistive substrate as taught herein may be comprised of a plurality of individual fibers that optionally may be cut to a predetermined length and randomly oriented to form the resistive substrate. The resistive substrate may conform to virtually any shape. For example, the resistive substrate may be wrapped around a circular object so that the circular object is heated. The resistive substrate may include a plurality of fibers that form a resistive substrate. The resistive substrate may be made up of about 50 percent by weight or more, about 60 percent by weight more, preferably about 70 percent by weight or more, or more preferably about 80 percent by weight or more fibers. The resistive substrate may be made up of about 82 percent by weight or more, 85 percent by weight or more, about 90 percent by weight or more, about 92 percent by weight or more, or even about 95 percent by weight or more fibers. The resistive substrate may be made of about 99 percent by weight or less, about 98 percent by weight or less, or about 97 percent by weight or less fibers (i.e., from about 80 percent by weight to about 90 percent by weight).

Preferably, the plurality of fibers are randomly distributed throughout the resistive substrate. More preferably, the plurality of fibers have an average short fiber length so that when combined, the resistive substrate has a nonwoven structure and the fibers cannot be woven around each other using a mechanical device. Even more preferably, the average fiber length and orientation of the fibers produces a substantially constant heat gradient across, a substantially constant heat density, or both across the heater when power is applied. The fibers may be sufficiently randomly oriented so that the orientation of the fibers forces the power to move and spread throughout the resistive substrate proving substantially uniform heating, a uniform heat density, or both and the power is free of traveling along one specific line. In an example, the resistive substrate taught herein is substantially free of fiber orientation so that the resistive substrate does not have a machine direction, a cross direction, or both. The resistive substrate may be free of individual heating wires, heating threads, or both and the heating may occur through the randomly oriented fibers. Randomly oriented as discussed herein means that about 60 of the fibers or less, about 50 or less, preferably about 40 percent or less, more preferably about 30 percent or less, or even more preferably about 20 percent or less of the fibers are oriented in the same direction. The average fiber length may affect the orientation of the fibers.

The average fiber length may be any length so that a nonwoven sheet is formed and the sheet has sufficient strength to be bent, folded, cut, conduct power, be pushed into a trench, or a combination thereof. The average fiber length may be any length so that the fibers have sufficient contact with each other so that when power is applied, power passes from fiber to fiber and the heater (and resistive substrate) produces a substantially even temperature gradient (i.e., the temperature when measured randomly across the heater is within about ±5° C. or less, about ±3° C. or less, or about ±2° C. or less). The average fiber length may be about 130 mm or less, about 110 mm or less, about 100 mm or less, about 80 mm or less, about 60 mm or less, about 50 mm or less. Preferably, the average fiber length is relatively short. Thus, the average fiber length may be about 40 mm or less, about 30 mm or less, preferably about 28 mm or less, more preferably about 25 mm or less, or even more preferably about 22 mm or less. The average fiber length as discussed herein may have a standard deviation of ±5 mm or less, ±4 mm or less, preferably ±3 mm or less, more preferably about ±2 mm or less, or even more preferably about ±1 mm or less, or most preferably about ±0.5 mm or less. The maximum fiber length (i.e., the longest fiber in the resistive substrate) may be about 200 mm or less, preferably about 175 mm or less, more preferably about 150 mm or less, even more preferably about 100 mm or less, or most preferably about 50 mm or less.

The resistive substrate may be made of any nonwoven material that conducts electricity and produces heat. The resistive substrate may be made of a material that may be produced using a spunlace process (e.g., hydroentanglement). The resistive substrate may include carbon, a metallic coated carbon, a polymer, a metallic coated polymer, a binder, or a combination thereof. Preferably, the resistive substrate includes a plurality of fibers made of carbon or a polymer, and the fibers optionally being coated with one or more layers of a metallic material. The resistive substrate may include about 50 percent by weight carbon or more, about 60 percent by weight carbon or more, about 75 percent by weight carbon or more, about 80 percent by weight carbon or more, preferably about 85 percent by weight carbon, more preferably about 90 percent by weight carbon or more, even more preferably about 95 percent by weight carbon or more, or most preferably about 97 percent by weight carbon or more. The resistive substrate may comprise 99 percent by weight carbon. The resistive substrate may comprise substantially about 100 percent by weight carbon. One or more coatings may be applied to the fibers before a layer is formed, one or more coatings may be applied to the fibers when the fibers are a layer (e.g., a fiber mat or fiber sheet), a first coating may be applied to the fibers and then a second coating may be applied to the fibers when they are part of the layer, or a combination thereof. In an example, a nylon mat may be formed and then the nylon mat may be coated with copper and then nickel so that the nickel prevents the copper from corroding and/or oxidizing. Polymers that the fiber may be made of are nylon, a polyester, polyurethane, polyamide, an aramid, a para-aramid, a meta-aramid, or a combination thereof. The fibers may be coated with any material that may conduct electricity. Metals that may be used to coat the carbon fibers, the polymer fibers, or both are copper, silver, gold, nickel, aluminum, tungsten, zinc, lithium, platinum, tin, titanium, platina 4, or a combination thereof. In one preferred embodiment the plurality of fibers are made of only of carbon. In another preferred embodiment the fibers are made of nylon or carbon and coated with nickel or silver. If a coated fiber is used the coating may be used as a percentage of the total weight of the resistive substrate. The percentage of total weight of the coating may be any weight so that when power is supplied to the resistive substrate the resistive substrate produces heat. Preferably, the percentage of the coating in the total weight of the resistive substrate may be a sufficient amount so that the resistive substrate upon an application of power heats up to a temperature from about 80° C. to about 110° C. The percentage of the coating in the total weight of the resistive substrate may be a sufficient amount so that the resistivity of the resistive substrate is from about 2Ω to about 8Ω and preferably from about 3Ω to about 7Ω. The coating may make up about 5 percent or more, about 10 percent or more, or preferably about 15 percent or more of the total weight of the resistive substrate. The coating may make up about 50 percent or less, about 40 percent or less, or about 30 percent or less of the total weight of the resistive substrate (i.e., from about 20 percent to about 25 percent of the total weight). An example of one metallized nylon nonwoven fleece is sold with a trade name HNV80 available from YSShield. Some examples of some carbon nonwovens are available under the trade names C10001xxxT Series, NC10004xxxT series, C100040xxT series available from Marktek Inc. The plurality of fibers discussed herein may be held together using a binder.

The binder may be any binder that may form a fixed connection between two or more adjacent fibers. The binder may be any binder that once set may bend; flex; be cut; be punched; resist ripping; resist tearing; be heated without melting, running, significantly softening; assist in conducting power, be free of preventing the transfer of power, or a combination thereof. The binder may be any binder that may bond to fibers made of any of the materials taught herein such as carbon, metalized carbon, a metallized polymer, or a combination thereof. The binder may be water soluble, alcohol soluble, a polyvinyl alcohol (PVA), a polyvinyl nitrate, a polyvinyl acetal, a polyvinyl acetate, a polybinyl butyral, a polyester binder, polyamide, a cross linked polyester binder, or a combination thereof. The binders may be used in a sufficient amount so that the plurality of fibers are held together and a nonwoven material is formed. The binders may be used in the heater in an amount of about 40 percent by weight or less, about 35 percent by weight or less, preferably about 30 percent by weight or less, more preferably about 25 percent by weight or less, or even about 20 percent by weight or less. The binders may be used in an amount of about 1 percent by weight or more, about 5 percent by weight or more, about 10 percent by weight or more, or even about 15 percent by weight or more

The resistive substrate is a nonwoven material. Preferably, the resistive substrate may be felt like (i.e., a nonwoven homogeneous flat structure). More preferably, the resistive substrate may be a nonwoven material with a randomly oriented microstructure. The resistive substrate may be a layer of the heater that produces heat. The heater may be free of holes. The heater may include holes. The holes may extend through one or more layers of the heater. Preferably, the holes extend through at least the backing, adhesive, closing layer, or a combination thereof. The holes may be any shape so that heat is created and the adjoining surface, person, item, device, or a combination thereof is heated. One or more or a portion of one or more wires, conductors, power application portions, or a combination thereof may extend through the holes in the resistive substrate. The holes may be round, oval, square, cross-like, long and thin, symmetrical, asymmetrical, geometric, non-geometric, or a combination thereof. The heater may include side cutouts. Preferably, the heater may be free of side cutouts. The heater and the resistive substrate may include a microstructure.

The microstructure of the resistive substrate may include a plurality of pores, a plurality of voids, or both. Voids and pores as discussed herein are part of the microstructure of the resistive substrate whereas through holes and cutouts are larger and are a space where, for example, material has been removed. The resistive substrate may have a sufficient amount of voids and/or pores so that air from an air mover can pass through the resistive substrate, the fibers of the resistive substrate are randomly oriented, power is randomly distributed throughout the resistive substrate, a protecting layer can penetrate through the resistive substrate, or a combination thereof. The voids and/or pores of the resistive substrate may represent an area of about 10 percent or more, about 15 percent or more, about 20 percent or more, about 25 percent or more, about 30 percent or more, or even about 40 percent or more of a total surface area of the resistive substrate. The voids and/or pores of the resistive substrate may represent an area of about 90 percent or less, about 80 percent or less, about 70 percent or less, about 60 percent or less, or about 50 percent or less of the total surface area of the resistive substrate. The resistive substrate may have a sufficient amount of fibers and/or material in the resistive substrate so that one or more other layers may be connected to the resistive substrate, a protecting layer can form a planar surface over the resistive substrate, or both.

The heater may include power application portions. The heater may be free of any additional electrically conducting layers (e.g., busses, electrodes, terminals, traces, spurs, braches, or a combination thereof). Preferably, the heater includes power application portions (e.g., busses, electrodes, or both) that extend substantially along a length and/or width of the heater and assist in applying power to the heater. More preferably, the resistive substrate is free of terminals that connect the power source to the heater (i.e., a single point of power application). The resistive substrate may be free of gold, silver, copper, or a combination thereof. The resistive substrate may include positive temperature coefficient material (PTC). The resistive substrate may be free of any additional electrically conducting layers, positive temperature coefficient layers, additives, or a combination thereof that are added to the resistive substrate in a separate step, that assist in producing heat, or both. Preferably, the resistive substrate may be the only portion of the heater required to produce heat. The configuration of the resistive substrate may be used to vary a resistivity, surface power density, or both of the resistive substrate.

The resistive substrate may be characterized by an areal weight (i.e., weight per unit areas of a fabric). The areal weight may be about 3 g/m² or more, preferably about 4 g/m² or more, more preferably about 6 g/m² or more, or most preferably about 8 g/m² or more. The areal weight may be about 500 g/m² or less, about 200 g/m² or less, preferably about 100 g/m² or less, or more preferably about 85 g/m² or less (i.e., 12 g/m², 14 g/m², or 17 g/m²). The material of the resistive substrate possess a basis weight. The basis weight of the resistive substrate may be about 6 g/m² or more, or about 8 g/m² or more. The basis weight of the resistive substrate may be about 200 g/m² or less, about 150 g/m² or less, preferably about 100 g/m² or less, or more preferably about 85 g/m² or less (i.e., 12 g/m², 14 g/m², or 17 g/m²).

The material of the resistive substrate possess a thickness. The resistive substrate may be sufficiently thin so that the resistivity is from about 2Ω to about 8Ω and preferably from about 3Ω to about 7Ω and heating performance of the resistive substrate is improved when compared to resistive substrate lower than the resistive substrate taught herein. The thickness of the resistive substrate may be about 0.001 mm or more, about 0.005 mm or more, or preferably about 0.07 mm or more. The thickness of the resistive substrate may be about 30 mm or less, about 10 mm or less, preferably about 5 mm or less, more preferably about 2 mm or less, or more preferably about 1.0 mm or less. The resistive substrate may be made of a material taught herein including the teachings of paragraph nos. 0028-0049 of U.S. Patent Application Publication No. 2013/0186884 the teachings of which are expressly incorporated by reference herein for all purposes including those pertaining to resistivity, surface power density, areal weight, basis weight, fiber diameter, thickness, thermal conductivity, specific heat, breaking tensile, a secondary treatment, or a combination thereof.

The resistive substrate may be attached to at least two power application portions and upon application of electricity (e.g., power) the resistive substrate produces heat. The resistive substrate when connected to a positive power source and a negative power source (i.e., power application portions) may produce heat. Preferably, the resistive substrate is free of terminals that connect to busses and/or electrodes to the resistive substrate. The terminal may directly and/or indirectly attach to the resistive substrate using any device so that electricity enters the resistive substrate through the terminals and the resistive substrate produces heat. The terminals may be crimped onto the power application portions. For example, the power applications may include terminals that connect a power source to the power applications. The power application portions may be connected by sewing, bonding, a mechanical fastener, or a combination thereof to the resistive substrate, each power application layer, or both. Preferably, the resistive substrate may free of terminals directly attached to the resistive substrate (i.e., a single point of power application). The heater may be free of mechanical fasters that attach a power application portions to the heater. For example, the resistive substrate may not have a mechanical attachment device that grips the resistive substrate and secures one or more wires to the heater. The resistive substrate may include two or more power applications that assist in supplying power to the resistive substrate. The two or more power applications may be located at any location on the heater. Preferably, the two or more power applications are spaced apart. The two or more power applications may be spaced a sufficient distance apart so that the heater is partially and/or entirely energized upon an application of power. More preferably, the two or more power applications are located in an edge region of the heater. For example, one power application may be located along one edge of the heater and a second power application may be located along the opposing edge so that power travels through the heater as the power travels from the first edge to the second edge.

The power application portions may include one or more wires and preferably two or more wires that are interwoven together or are connected to one or more wires that provide power to the power application portions. The wires may be made of any conductive material that assists in transferring power to the resistive substrate so that heat is produced. Each wire may have a resistivity of about 5 Ω*m or less, about 2 Ω*m or less, or about 1 Ω*m or less. Each wire may have a resistivity of about 0.01 Ω*m or more, about 0.05 Ω*m or more, or about 0.01 Ω*m or more (i.e., about 0.25 Ω*m). The wires are preferably made of copper, silver, gold, nickel, or a combination thereof and/or coated with copper, silver, gold, nickel, or a combination thereof so that power is transferred to the resistive substrate. The power application may be made of or include carbon. The carbon material may function to conduct electricity. The carbon material may be substantially resistant to cutting and tearing. The carbon material may be resistant to heat and fire. The power applications portions when made of carbon may be substantially entirely made of carbon. The power application powers may be made of carbon nanotubes. Preferably, the power application portions may be made of a carbon nanotube yarn, a carbon nanotube film, or a combination of both. The power application portions when made of a carbon nanotube yarn may include one or more strands, two or more strands, three or more strand, or even four or more strands. The strands may extend parallel to one another along a length of the heater, resistive substrate, or both. The strands may overlap as they extend along a length of the heater, resistive substrate, or both. The strands may wind around each other, be braided, twisted together, or a combination as the two or more strands extend along a length of the heater, resistive substrate, or both. The carbon material and preferably the carbon nanotube yarn may have a tensile strength of about 40 MPa or more, about 50 MPa or more, or even about 60 MPa or more when measured using ASTM D638. The carbon material and preferably the carbon nanotube yarn may have a tensile strength of about 200 MPa or less, about 100 MPa or less (e.g., about 66 MPa) when measured using ASTM D638. The carbon nanotube yarn may have a conductivity of about 40 MS/m or more, about 45 MS/m or more, about 50 MS/m or more, or even about 60 MS/m or more. The carbon nanotube yarn may have a conductivity of about 120 MS/m or less, about 100 MS/m or less, or about 80 MS/m or less. One commercially available carbon nanotube yard is sold under the trade name Miralon® yarn by nanocomptech. The power application portions may be made of graphite. The graphite may be in sheet form (e.g., a film) and the sheet may be formed into strips. For example, by cutting, die cutting, stamping, or a combination thereof. The sheet may have a thickness of about 0.001 mm or more, about 0.005 mm or more, preferably about 0.01 mm or more, or about 0.05 mm or more. The sheet may have a thickness of about 1 mm or less, about 0.5 mm or less, or about 0.1 mm or less. The sheet may have a conductivity of about 10,000 S/cm or more, preferably about 20,000 S/cm or more, about 30,000 S/cm or more, or even about 50,000 S/cm or more. The sheet may have a conductivity of about 200,000 S/cm or less, about 150,000 S/cm or less, or about 100,000 S/cm or less. The strips may then be attached to the heater, the resistive substrate, or both. The power application portions may be connected to the resistive substrate by any device that fixedly connects the power application portions to the heater and does not substantially interfere with the transfer of power to the resistive substrate. Some examples of attachment devices and/or methods that may be used are sewing, gluing (e.g., with conductive or non-conductive glue), bonding, interweaving, stapling, or a combination thereof. For example, a graphite strip may be connected to a resistive substrate using Spunfab® and then rivets are used to terminate the graphite strip to a power source such as wires.

The attachment devices function to connect the power application portions to the resistive substrate. The attachment devices may extend through one or more layers. The attachment devices may extend through two or more, three or more, or even four or more layers of the heater. The attachment devices may extend through the resistive substrate, adhesive, and one or more backings. The one or more attachment devices may be a thread. The one or more attachment devices may be conductive. Preferably, the one or more attachment devices are non-conductive. The attachment devices may electrically connect, physically connect, or both the power application portions to the resistive substrate. Preferably, the attachment devices only physically connect the power application portions to the resistive substrate. The one or more attachment devices may connect the power application portions to the resistive substrate so that upon application of power the resistive substrate becomes hot. The one or more attachment portions may hold the power application portions in place so that one or more wires that support power are attached to the resistive substrate.

The one or more wires may be directly connected to the power application portions. The one or more wires may extend through the power application portions and out one or both ends of the power application portions. The one or more wires may be connected to the power application portions. The one or more wires may be an integral part of the power application portions. The one or more wires may be a terminal end of the power application portions. The one or more wires may be connected to one or more conductors via one or more electrical connectors.

The one or more electrical connectors function to connect a conductor to the resistive substrate. The one or more electrical connectors may connect one or more conductors to the power application portions, the wires, or both. The one or more electrical connectors may form a water tight connection. The one or more electrical connectors may form a bridge between wires and conductors so that power is supplied to the resistive substrate.

The one or more conductors may function to supply power to the heater. The one or more conductors may be wires. The one or more conductors may be connected directly to a power supply. The one or more conductors may provide power from a power supply to the heater. The one or more conductors may be a larger gauge than the wires or a substantially similar gauge as the wires. The one or more conductors, power application portions, or both may be located on a side of the resistive substrate that is free of adhesive.

The adhesive layer may be any adhesive sheet or film that forms a connection upon an application of heat. The adhesive layer may have a solid form that is applied to one or more layers of a heater and heated to form a connection between two or more layers. The adhesive layer may be a liquid that is applied to one or more layers and forms a connection with the one or more layers upon being applied. The adhesive layer may a polyamide. The adhesive layer preferably is a non-woven material. The adhesive layer preferably is a plurality of fibers and/or fiber-like adhesive particles interconnected with voids and/or pores between the interconnected fibers and/or fiber-like adhesive particles. The adhesive layer may have a plurality of voids, a plurality of pores, or both. The adhesive layer may have a sufficient amount of voids and/or pores so that when the adhesive is connecting two or more electrically conducting layers (e.g., one or more layers of the power application, the resistive substrate, or both) power may pass through the voids and/or pores, an electrical connection may be maintained, the adhesive layer does not interfere with the supply of power between two or more electrically conducting layers, or a combination thereof, and a connection may be formed between the two or more layers. The voids and/or pores of the adhesive layer may represent an area of about 10 percent or more, about 20 percent or more, about 30 percent or more, preferably about 40 percent or more, or more preferably about 45 percent or more of a total surface area of the resistive substrate. The voids and/or pores of the adhesive layer may represent an area of about 90 percent or less, about 80 percent or less, about 70 percent or less, or about 60 percent or less of the total surface area of the resistive substrate. An example of an adhesive fabric that may be used is sold under the trade name Spunfab available from Spunfab Ltd. The adhesive may be applied to one or more layers of the heater before the layers are connected together. For example, the adhesive may be applied to the resistive substrate before the resistive substrate is applied to any other layers such as the backing.

The adhesive may connect one or more layers of backing, a partial heater, the resistive substrate, a patch, or a combination thereof. The adhesive when connected to a backing may be a backing adhesive; when connected to a substrate may be a substrate adhesive; and when connected to a patch may be a patch adhesive all of which are generically referred to herein as adhesive unless the adhesive is referenced to with a specific layer. The adhesive may be applied to a layer and form a preformed layer (i.e., a partial heater). The adhesive when applied to a layer may reside entirely on a surface of the layer. For example, the adhesive may be applied to the resistive substrate and the adhesive and resistive substrate may be two discrete and generally planar layers. Preferably, the adhesive partially penetrates into one or more layers. For example, the adhesive may be applied in liquid form or partially melted so that the adhesive penetrates into the layer (e.g., resistive substrate, patch, backing) so that the adhesive is interspersed throughout at least a portion of the layer. The adhesive may penetrate through at least about 10 percent or more, about 20 percent or more, about 30 percent or more, about 40 percent or more, or even about 50 percent or more of a layer. The adhesive may penetrate through at least about 99 percent or less, about 95 percent or less, about 90 percent or less, about 80 percent or less, or about 70 percent or less of a layer. The adhesive may include a penetrating portion and a non-penetrating portion. The adhesive may have a portion that extends from one side of a layer (i.e., non-penetrating portion). For example, the layer have a first surface that is free of adhesive (i.e., the adhesive did not penetrate into the layer) and a second surface that the adhesive extends from. The adhesive may overhang one or more edges of the layer. The adhesive may form a periphery around the edges of the layer. The adhesive may only cover sides (i.e., major regions (e.g., length and width)) of the layer. The adhesive may cover edges (i.e., minor region (e.g., a thickness)) of the layer. The adhesive may be a sheet that is cut to be larger than a layer and upon heating a portion of the adhesive may penetrate into the layer and a portion may extend from one side and form a peripheral edge around the layer. The adhesive may interpenetrate the resistive substrate, one or more backings, the patch, or a combination thereof prior to connection with any other layers. The side of the layer that is free of adhesive may be connected to one or more structures of the heater with a device other than adhesive (e.g., the power application portions may be connected to the layer via an attachment device). The side of the layer that has overhanging adhesive may be applied to a side of another layer that is free of adhesive. The non-penetrating portion of the adhesive may be covered by a release paper so that the layer is not inadvertently adhered to another layer. The release paper may be removed before two layers are connected together. The adhesive of one layer and the adhesive of a second layer may be combined together forming a single layer or a combined adhesive when the two layers are joined together. For example, when the closing layer is applied over the resistive substrate, the power application portions, or both the backing adhesive on the closing layer may combine with the substrate adhesive and form a single layer. The final heater may have two or more or three or more layers of adhesive that may be combined together to form a single layer of adhesive that spans through two or more or even through or more layers of the heater. The two or more layers of adhesive may be combined in the resistive substrate, backing, or both. Preferably, the resistive substrate will be sufficiently penetrated by a substrate adhesive so that a backing adhesive extends into the resistive substrate and forms a single layer of adhesive. The single layer of adhesive may extend through one or more layers of backing, the resistive substrate, the closing layer, patch, power application portions, or a combination thereof.

The heater may be comprised of only a resistive substrate (e.g., the heater may include one layer). Preferably, the heater includes at least three layers. However, the heater may be free of any layers that are secured over the resistive substrate. For example, the heater may include a layer that interpenetrates the resistive substrate and forms a partially and or fully protecting layer over the resistive substrate. Preferably, the heater includes one or more layers of backing (e.g., forward cover layer, an rearward cover layer, or both). The forward cover layer, the rearward cover layer, or both as discussed herein are a backing (i.e., the backing on a forward side of the heater is a forward cover layer and the backing on the rear side of the heater is a rearward cover layer). The heater when it includes a forward cover layer and a rearward cover layer may be made of the same material, a different material, or both. The backing may be made of any material that protects that heater and exhibits one or more of the characteristics listed herein. The backing may be made of a polymeric material, a woven material, a nonwoven material, or a combination thereof. The layers of backing may substantially encapsulate the heater layer, form a hermetic seal around the resistive substrate, or both. The resistive substrate may be sandwiched between two layers of backing (e.g., the forward cover layer and the rearward cover layer), but a hermetic seal may not be formed. The backing may be moisture resistant; may be flexed, bent, folded, crimped, or a combination thereof repeatedly without plastically deforming, elastically deforming, failing, breaking, tearing, creasing, or a combination thereof; heat resistant; flame resistant; chemical resistant; or a combination thereof. The backing may be a film. The backing may be made of or include a polymeric material that glued and/or surface melted (i.e., heat laminated to the resistive substrate). The polymeric material may be a foam, open cell foam, closed cell foam, polyester, polyurethane, polyethylene terephthalate; polyvinyl fluoride, polyethylene, polyetherimide, acrylic adhesive, acrylic, urethane, silicone, rubber (e.g., natural, synthetic, acrylic, butadiene, butyl, chlorobutyl, chlorinated polyethylene, chlorosulphonated polyethylene, ethylene propylene rubber, or a mixture thereof); or a combination thereof. The backing may be a protective layer connected to the resistive substrate, the resistive substrate may include a protecting layer, or both

The resistive substrate may incorporate partially and/or entirely a discrete material (i.e., a protecting layer) into the resistive substrate so that the resistive substrate is protected by the protecting layer. The protecting layer may be a reinforcing layer. For example, the protecting layer may reinforce the individual fibers so that the fibers are strengthened and the strength characteristics of the heater is increases (e.g., tensile strength, tearing strength, fold strength, the like, or a combination thereof). The protecting layer may be any material that becomes interwoven into the resistive substrate so that the protecting layer increases the strength of the resistive substrate (e.g., tensile strength, tearing strength, fold strength, the like, or a combination thereof), the insulation properties of the resistive substrate, or both. Preferably, the protecting layer increases the strength of the resistive substrate and forms a partially dielectric coating over the heater or a fully dielectric coating over the heater. The protecting layer may form an insulating layer over the forward surface, the rearward surface, the side edges, or a combination thereof of the resistive substrate so that the resistive substrate on the outside has dielectric characteristics. The protecting layer may be made of any material as discussed herein for the forward cover layer, the rearward cover layer, or both. The protecting layer may form a layer on a forward side, a rearward side, a side edge, a top edge, a bottom edge, or a combination thereof so that the protecting layer is a dielectric layer over the resistive substrate. The protecting layer may be in addition to any adhesive that partially or fully penetrates into the resistive substrate. The protecting layer may fill voids and/or pores that are not filled by the adhesive. The protecting layer may fill the pores and/or voids between the individual fibers of the resistive substrate. Preferably, the protecting layer fills the pores and/or voids between the individual fibers of the resistive substrate, but does not entirely surround the individual fibers so that the connections and/or electrical connections between the fibers remain intact. The protecting layer may be made of a liquid material that coats and/or penetrates into the resistive substrate. Preferably, the protecting layer penetrates into the resistive substrate, the heater, or both and coats the portions of the heater, the resistive substrate, or both that are contacted by the protecting layer. The protecting layer may be applied by dipping, spraying, brushing, rolling, the like, or a combination thereof. The protecting layer may be applied to a resistive substrate before the power applications are connected to the resistive substrate, after the power applications are applied, or a time therebetween. For example, if a completely dielectric heating is desired then the power applications are applied to the resistive substrate and then the protecting layer is applied over both the resistive substrate and the power application layers. In another example, if a non-dielectric heater that is high in strength is desired then the protecting layer may be applied to the resistive substrate and then the power applications applied to the resistive substrate. Preferred materials that may be used for the protecting layer are urethane and acrylic, although as previously discussed the materials for the forward cover layer and the rearward cover layer may be used. The material properties of the protecting layer may affect the final characteristics of the heater (e.g., conductivity of the heater, strength, the like, or a combination thereof). The protecting layer may be added to a portion of the heater before a complete heater is formed. The protecting layer may be part of a partial heater.

The partial heater may include one or more layers. Preferably, the partial heater is two or more layers that are connected together. The partial heater may be two or more layers that are joined in a prefabricated step and then combined to two or more other layers to form a partial heater with more layers or a final heater. The partial heater as discussed herein may be any layer that is partially penetrated by adhesive so that the layer has a side that is free of adhesive and a side that has adhesive overhanging the layer (of forming a partial layer of adhesive extending from the layer). The partial heater may include a backing layer. The partial heater may include one or more power application portions. The partial heater may include one or more attachment devices attaching one or more layers or components (e.g., power application portions). The partial heater may include a resistive substrate that is partially penetrated by the substrate adhesive; a backing layer that is partially penetrated by a backing adhesive; a patch that is partially penetrated by a patch adhesive; or a combination thereof. One or more partial heaters may be formed before being combined together to form a final heater or a complete heater. The one or more partial heaters may be partial heater layers that are prefabricated at separate times and/or locations and then the partial heater layers are combined to form a final heater. The one or more partial heaters may be formed and then processed in a subsequent step before being combined with other layers or other partial heaters to form a complete heater. The one or more partial heaters may be cut into one or more partial heater strips and preferably a plurality of partial heater strips.

The partial heater strips may function to heat and regions between the partial heater strips may be free of heat. The plurality of partial heater strips may be cut, slit, or both by a slitter, cutting device, scissors, or a combination thereof to create the plurality of partial heater strips. Preferably, the partial heater strips are formed by sending a partial heater through a slitter that cuts a roll of a partial heater into the plurality of partial heater strips. The plurality of heater strips may be of uniform lengths, uniform widths, or both. The plurality of heater strips may be of different widths, different lengths, or both. The partial heater strips may have a length that is sufficient to wrap a steering wheel, or stretch across a width of a seat. The partial heater strips may have a length of about 20 cm or more, about 25 cm or more, about 30 cm or more, or even about 40 cm or more. The partial heater strips may have a length of about 100 cm or less, about 75 cm or less, about 60 cm or less, or about 50 cm or less. The partial heater strips may have a width that is sufficient to wrap around a circumference of a cross-section of a steering wheel; span from trench to trench of a cushion of a seat, or cover an entire surface of a vehicle seat (e.g., backrest or bun). The plurality of partial heater strips may be discrete pieces once slit. The plurality of partial heater strips may be arranged on one or more backings. The plurality of partial heater strips may be arranged on one or more backings so that a gap is located between each of the plurality of heater strips.

The one or more gaps may function to be free of heating. The one or more gaps may function to extend into a trench so that an area between to partial heater portions or two heater portions is not heated. The one or more gaps may be sufficiently large so that the backing extends into a trench and the heater layer remains out of the trench. The one or more gaps may be about 1 cm or more, about 3 cm or more, or about 5 cm or more. The one or more gaps may be about 30 cm or less, about 20 cm or less, or about 15 cm or less. The one or more power application portions may extend over or around the gaps, the trenches, or both. The one or more power application portions may extend over the gaps, through the trenches, or both. The gaps between each of the plurality of strips are free of resistive substrate so that upon application of power the gaps are free of heat. The one or more power application portions may be connected to the backing in the gaps. The one or more power application portions may electrically, physically, or both connect two or more heater strips. The one or more gaps may provide stretch in the heater, flexible regions, or both. The one or more gaps may be located in high stress regions. The one or more gaps may be located between heater strips and the gaps and heater strips may form a portion the heater as discussed herein. The one or more gaps, the plurality of partial heater strips, or both may be partially or entirely covered by a closing layer.

The closing layer may function to cover the electrical portions of the heater (e.g., power application portions, wires, or both), cover the resistive substrate, or both. The closing layer may include a material that is the same as the backing. The closing layer may be a backing with adhesive. Preferably, the closing layer incudes the backing and adhesive partially penetrated into the backing and partially extending from the backing so that once the closing layer is applied over the resistive substrate, the resistive substrate is substantially encapsulated or entirely encapsulated between two layers of backing. The closing layer may have a thickness that is greater than a thickness of only a layer of backing. The closing layer may form an upper surface of the heater. The closing layer may be partially covered by one or more wires, thermistors, patches, or a combination thereof. The closing layer may include one or more holes, slits, cutouts, or a combination thereof that wires, thermistors, attachment devices, or a combination thereof extend through. The closing layer may be free of holes, cutouts, slits, or a combination thereof. The closing layer may have holes that extend through the backing, the adhesive, or both the backing and the adhesive. The closing layer may be covered by one or more patches or the patch may be located on an opposite side of the heater as the closing layer.

The one or more patches function to cover one or more electrical components. The patch may be a layer of backing and a layer of adhesive. The adhesive may be partially penetrated into the patch before the patch is applied. The one or more patches may extend on one or more sides of a heater. The patch may extend from a first major side around an edge and onto a second major side. The patch may only extend along one major side. The patch may cover about 50 percent or less, 40 percent or less, or even about 30 percent or less of a major side. The patch may extend over one or more thermistors, one or more wires, one or more electrical connectors, one or more conductors, one or more power application portions, or a combination thereof. Preferably, the patch extends directly over two or more wires, two or more conductors, two or more electrical connectors, and one or more thermistors. More preferably, the patch and a resistive layer, backing, or both form a sandwich that receives one or more power application portions, one or more wires, one or more electrical connectors, one or more conductors, or a combination thereof.

The one or more thermistors function to measure a temperature of the heater, the resistive substrate, or both. The one or more thermistors may be in direct contact with a resistive substrate. The one or more thermistors may extend through a hole in a backing, a closing layer, or both. The one or more thermistors may extend along a surface of the closing layer, a layer of backing, or both. The one or more thermistors may provide measurements to a controller and the controller may regulate the temperature of the heater.

The heater (e.g., resistive substrate, forward cover layer, rearward cover layer, adhesive layers, attachment layers, or a combination thereof) as discussed herein may have a high fold resistance. The heater may have sufficient fold resistance so that the heater when placed in a seat may withstand wear for about 5 years or more, preferably about 7 years or more, or more preferably use for 10 years or more. The heater may have sufficient fold resistance that the heater may withstand 50,000 cycles or more, preferably 100,000 cycles or more, or more preferably about 200,000 cycles or more in the Z-direction without the heater losing any function.

The heater as discussed herein may be produced using a process. The process may include one or more of the following steps produced in virtually any order. An adhesive may be partially infused into one or more layers of a heater so that a partial heater is formed. The adhesive may be partially penetrated into a substrate, patch, backing, closing layer, power application portion, or a combination thereof. The adhesive may be heated so that the adhesive penetrates at least partially into a layer. The heater may be cooled when a desired depth of penetration is achieved. A first partial heater portion may be formed. A second partial heater portion may be formed separate from the first partial heater portion. A layer of backing may be connected to the first partial heater, the second partial heater, or both. The first partial heater may include adhesive, resistive substrate, power application portions, attachment devices, or a combination thereof. Attaching one or more power applications to the resistive substrate. The power application portions may be applied by applying attachment devices. The attachment devices may be sewing that penetrates one or more layers to connect the power application portions. The first partial heater, the second partial heater, or both may be cut into strips. The partial heater strips may be applied to a layer of backing. The partial heater strips may be attached to backing by the adhesive that is integral into the first partial heater, the second partial heater, or both. A release film may be removed so that the adhesive attaches the first partial heater, the second partial heater, or both together, to a layer of backing, or both. Applying heat until two layers of adhesive connect and form a single layer of adhesive that fully penetrates the layer of backing, the resistive substrate, Attaching one or more wires, one or more non-woven conductive strips, one or more electrodes and/or buss bars, attaching one or more pre-assembled power applications, or a combination thereof. Heating the resistive substrate and the one or more wires, one or more non-woven conductive strips, one or more electrodes and/or buss bars, attaching one or more pre-assembled power applications, or a combination thereof so that an electrical connection is formed to the resistive substrate. Producing a pre-assembled power application by combining one or more wires, one or more non-woven conductive strips, one or more adhesive layers, one or more buss bars and/or electrodes, or a combination thereof together so that when placed on the heater and heated the adhesive connects the pre-assembled power application to the resistive substrate and an electrical connection is formed. Connecting the one or more power applications to a power source, a wire, or both. Applying a electrical connector (e.g., shrink tube) to the one or more power applications, power sources, wires, or a combination thereof so that during a step of heating the shrink tube shrinks and the one or more power applications and power sources, wires, or both are electrically and physical connected. Applying a forward cover layer, a rearward cover layer, a connection layer (e.g., adhesive layer, mechanical attachment layer, or both), or a combination thereof to the resistive substrate. Cutting the resistive substrate, a layer of backing, the first partial heater, the second partial heater, or a combination thereof so that a through hole extends therethrough. Attaching a thermistor to a partial heater, the heater, or both. Moving one or more wires, conductors, thermistors, or a combination thereof through the one or more holes. Cutting one or more heaters or one or more partial heaters out of a sheet of partial heaters or completed heaters. Electrically connecting the temperature sensor to a power source. Connecting (e.g., physically and/or electrically) the resistive substrate to a controller, a control module, or both. Connecting the heater to a vehicle seat, a floor, a steering wheel, a mirror, an insert, or a combination thereof.

As discussed herein the heater may be integrated into another component during the construction of the component so that the heater and the component form one unitary piece. For example, if the article is a molded part the heating medium, which forms the resistive substrate, may be added into the mold so that when a final article is created the heater layer is throughout the article and the entire article heats when electricity is added. The heating medium may be individual fibers. The heating medium may be a sheet. The heating medium may be sprinkled into the mold, cut and placed in the mold as a sheet, mixed into the molding material and both materials added to a mold together, or a combination thereof.

FIG. 1A is a side view illustrating a resistive substrate 10 and an adhesive 20 with the adhesive 20 is a substrate adhesive 20A, which is partially penetrating into the resistive substrate 10. The adhesive 20 is not fully penetrated into the resistive substrate 10 so that a portion 12 of the resistive substrate 10 is free of adhesive 20 and a portion 22 of the adhesive 20 extends from the resistive substrate 10.

FIG. 1B is a side view illustrating the resistive substrate 10 and adhesive 20 of FIG. 1 with a backing 30 connected to the resistive substrate 10 by the adhesive 20. The adhesive 20 has a portion 22 that extends below the resistive substrate and a portion 23 that extends beyond an edge of the resistive substrate 10 and the backing 30. The side view shows a portion of resistive substrate 10 that is free of adhesive (D1) and a thickness of adhesive (D2) that extends through the resistive substrate 10. The adhesive 20 includes a portion (D3) that extends below the resistive substrate 10 and into the backing 30. The adhesive 20 includes a portion (D4) that extends beyond an edge of the resistive substrate 10 and backing 30.

FIG. 10 is a side view illustrating partially completed heater 4 including that begins with the structure of FIG. 1B with a power application portion 50 attached to the portion of the resistive substrate 10 without adhesive via an attachment device 40. The attachment device 40 extends through the resistive substrate power application portions 50, resistive substrate 10, adhesive 20, and backing 30 so that the power application portion 50 is both physically and electrically connected to the resistive substrate 10.

FIG. 1D illustrates a sheet of partially completed heaters 4 being cut apart so that individually heaters are created with all of the components of FIGS. 1A-10.

FIG. 2 is a top view of a partially completed heater 4. The partial heater 4 includes a pair of power application portions 50 located on opposing sides of the resistive substrate 10. A wire 54 is connected to each power application portion 50 and extends from the power application portions 50 so that the heater 4 can be powered.

FIG. 3 illustrates a closing layer 6 that includes a backing 30′ that is partially penetrated by adhesive 20′, which is a backing adhesive 20B. The adhesive has a portion 22′ that extends beyond the backing 30′ both along an edge (e.g., thickness) and a surface (e.g., layer) of the backing 30′. The backing 30′ includes a portion 34 that is free of adhesive 30′. The backing 30′ includes a hole that extends therethrough. The backing layer has a thickness (T1) that is free of adhesive 22′ and the adhesive 22′ extends below the backing 30′ a distance (T2).

FIG. 4A is a top view of the heater 2 with the closing layer 5 connected to the partial heater 4. The wires 54 extend from a bottom end of the heater 2. The adhesive 20 has a portion 22 that over hangs both the backing layer 30, on the top and the bottom, and the resistive substrate 10 so that a peripheral edge 24 of adhesive is formed around the heater 2.

FIG. 4B is a cross-sectional view of a stack up of the heater 2 of FIG. 4A cut along lines 4B-4B. The heater 4 has a backing 30′ on the top and the bottom. The top backing 30 overlies a power application portion 50 and is connected to the power application portion by adhesive 20 that partially penetrates into the backing 30. The backing 30 includes a hole 36 that extends to the resistive substrate 10. The power application portion 50 includes a wire 54 extending therefrom for connecting the heater 4 to a power source (not shown). The power application portion 50 is connected to a resistive substrate 10 and the bottom backing 30 by an attachment device 40 that extends through the resistive substrate 10, backing 30, and the attachment device 40. The adhesive 20 of the closing layer 6 penetrates into the power application portions 50 and resistive substrate 10 so that the resistive substrate 10 is fully incorporated into adhesive 20. As shown, the adhesive 20 of the closing layer 6 and the adhesive 20 of the partial heater 4 penetrate and meet forming a combined adhesive (or a single layer) 20D so that the adhesive 20 of the closing layer 6 and the partial heater 4 completely penetrate the resistive substrate 10.

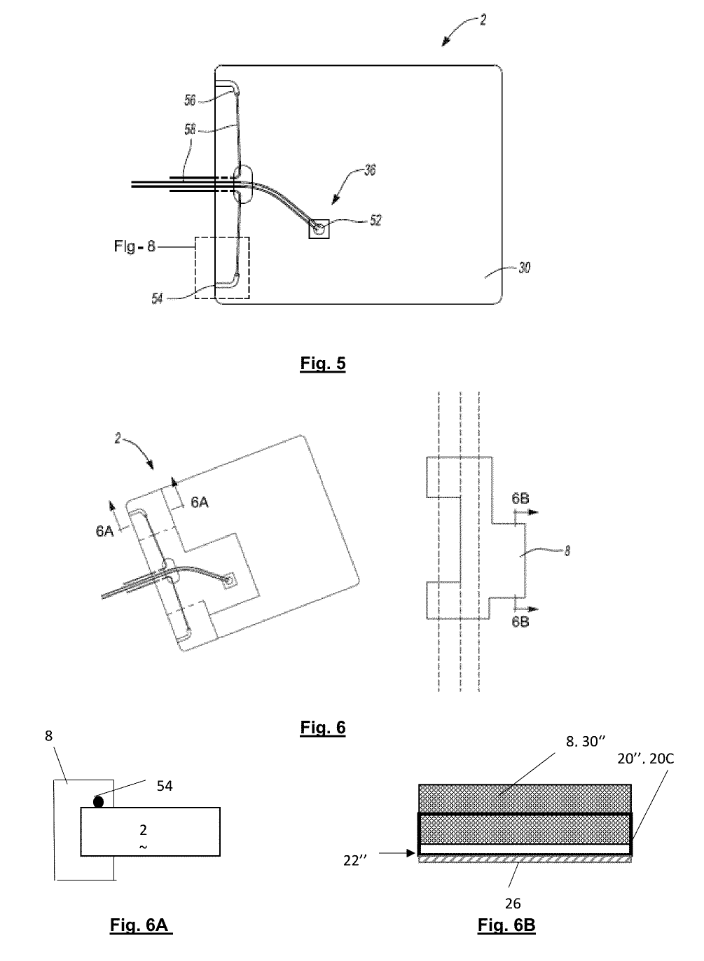

FIG. 5 illustrates a heater 2 including a thermistor 52 located within the hole 36 in the backing 30. The thermistor 52 includes conductors 58 that extend on the outside of the backing 30 and combine with conductors 58 that supply power to the power application portions (not shown) of the heater 2. The conductors 58 extend into an electrical connector 56 that joins the conductors 58 to the wires 54. The electrical connector 56 creates a waterproof connection between the conductors 58 and the wires 54. The conductors 58, wires 54, and electrical connectors 56 extend along a top surface (or a bottom surface) of the heater 2.

FIG. 6 illustrates a partial exploded view of the heater 2 of FIG. 5 showing a patch pattern on the heater where the patch 8 extends over and covers the components on a front of the heater 2, with the patch 8 located next to the heater 2.

FIG. 6A illustrates a cross-sectional view along lines 6A-6A of FIG. 5. The cross section shows the heater 2 with the patch 8 wrapped around an end of the heater 2 with the wires 54 located between the patch 8 and heater 2.

FIG. 6B illustrates a cross-sectional view along lines 6B-6B of the patch 8 of FIG. 6. The patch 8 is a backing 30″ that is partially penetrated by an adhesive 20″, which is a patch adhesive 20C) with a portion 22″ of the adhesive extending from a side of the backing 30″. The adhesive 20″ is covered by a release paper 26.

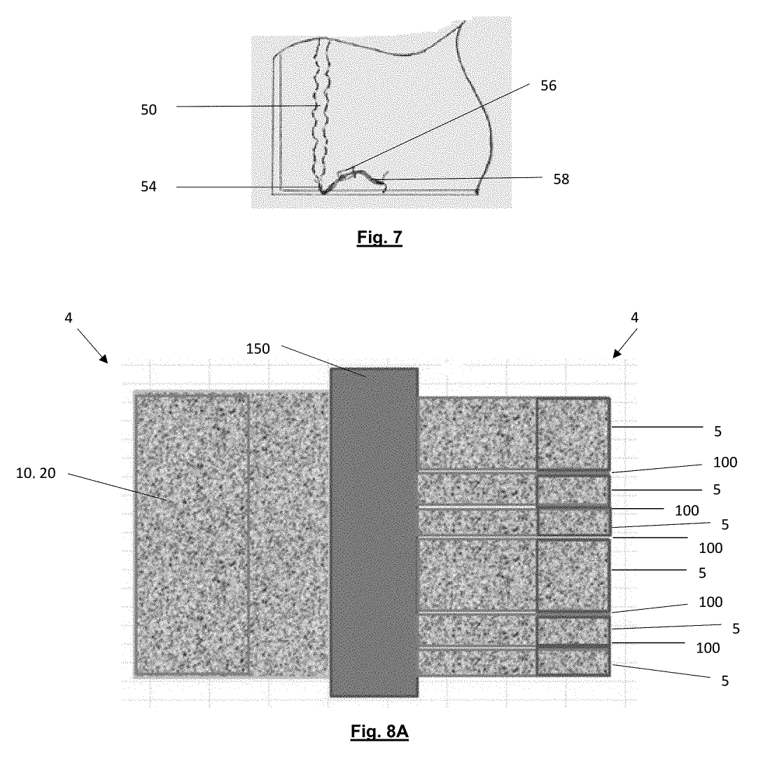

FIG. 7 is a close up view of the wires 54 extending from the power application portions 50 and an electrical connector 56 that connects the wires 54 to a conductor 58.

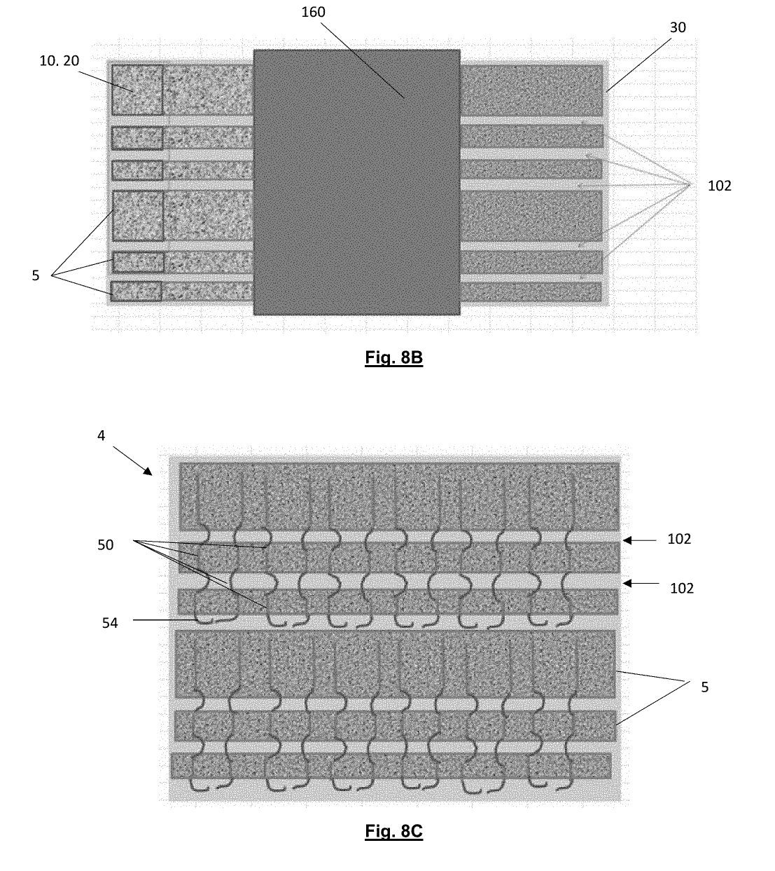

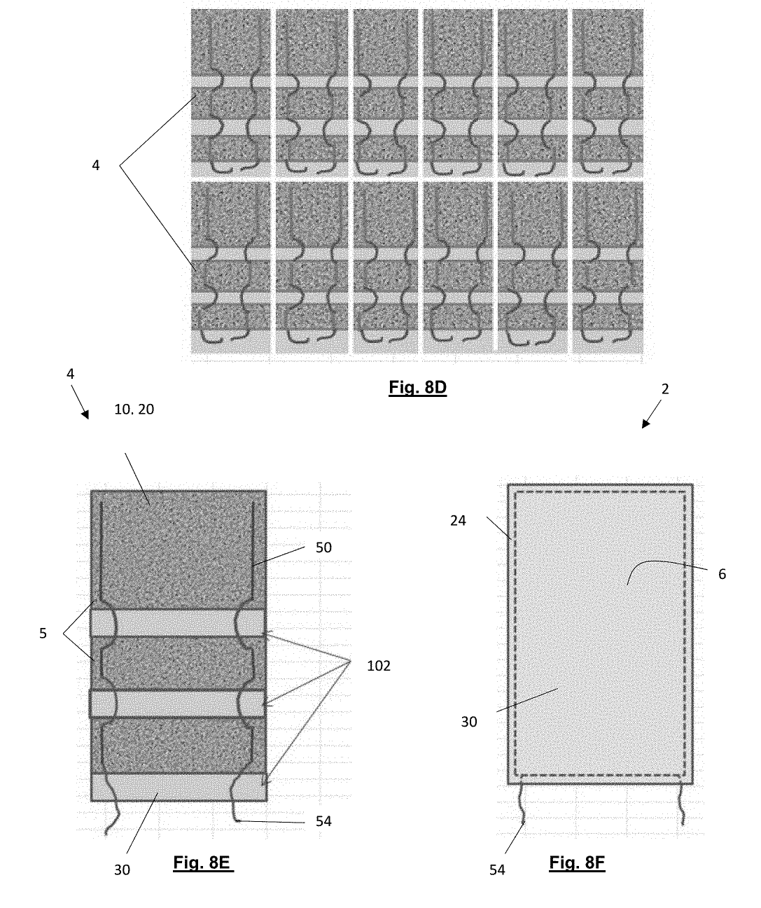

FIG. 8A illustrates a process where the partial heater 4 of FIG. 1A that includes adhesive 20 and a backing 30. The partial heater 4 is placed through a slitter 150 that cuts the partial heater 4 into a plurality of partial heater strips 5 that are separated by slits 100.

FIG. 8B illustrates a step of laminating the partial heater strips 5 from FIG. 8A that include a resistive substrate 10 and adhesive 20 to a backing 30. The laminator 160 secures the resistive substrate 10 and adhesive 20 to the backing 30 so that a gap 102 is located between and maintained between each of the partial heater strips 5.

FIG. 8C illustrates a step of attaching power application portions 50 and wires 54 to the partial heater 4 from FIG. 8B. The power application portions 50 extend from partial heater strip 5 to partial heater strip 5 and extend over the gaps 102 that are free of resistive substrate (i.e., the partial heater 4) so that the gaps 102 are not heated.

FIG. 8D illustrates the partial heater 4 of FIG. 8C being cut into a plurality of individual heaters.

FIG. 8E illustrates a single partial heater 4 from FIG. 8D. The partial heater 4 includes a base 30 that the resistive substrate 10 and adhesive 20 are connected. Power application portions 50 extend from partial heater strip 5 to partial heater strip 5 and over the gaps 102 where no resistive substrate 10 or adhesive 20 are present. A wire 54 is connected to the power application portions 50 extends from an end of the partial heater 4.

FIG. 8F illustrates a top view of the heater 2 when the closer layer 6 is applied over the partial heater 4 from FIG. 8E. The closing layer 6 includes a backing 30 and forms a peripheral edge 24 that extends around the heater 2. The wires 54 extend out of the heater 2.

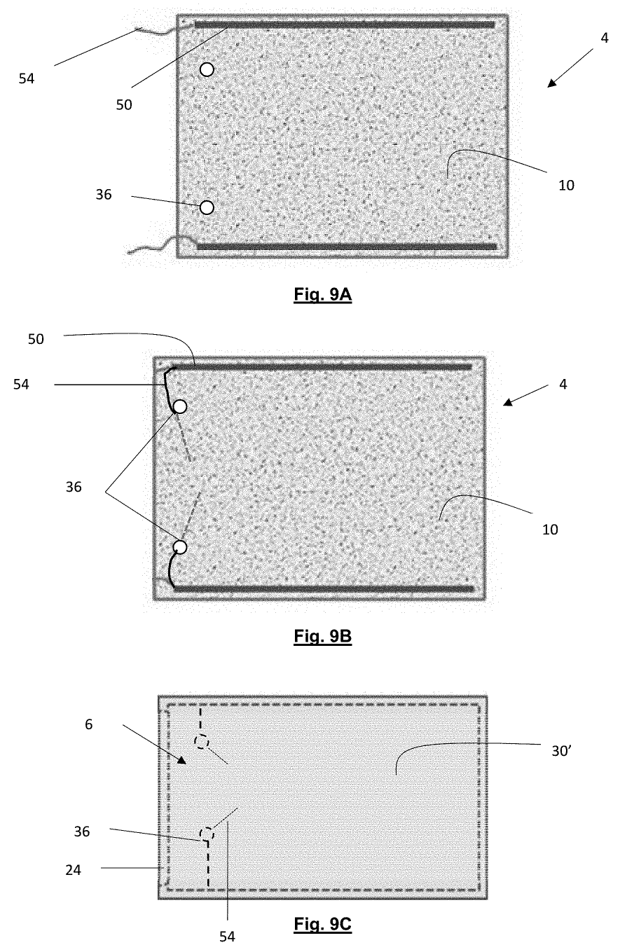

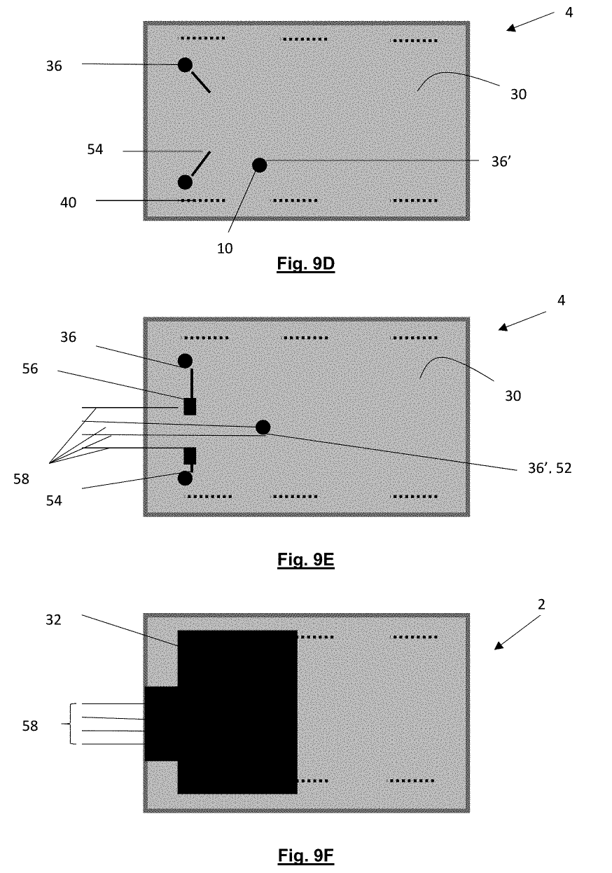

FIG. 9A is a top view of the partial heater 4 of FIG. 10. As shown the partial heater 4 includes a resistive substrate 10 with power application portions 50 along each edge. The power application portions 50 are each connected to wires 54 for supplying power to the resistive substrate 10. Holes 10 extend through the resistive substrate 10, adhesive 20 (not shown), and backing 30 (not shown).

FIG. 9B illustrates the wires 54 extending from the power application portions 50 extending thorough the holes 36 so that the wires are on a backside of the partial heater 4. As shown a portion of the wires 54 extend along a top of the resistive substrate 10 and then extend to the rear side of the partial heater 4.

FIG. 9C illustrates a closing layer 6 including a backing 30′ extending over the holes 36 and wires 54. The closing layer 6 has a peripheral edge 24 of adhesive about a perimeter of the closing layer 6.

FIG. 9D illustrates a top side of the partial heater 4 of FIG. 9C (i.e., FIG. 9C flipped over). The top side includes a backing layer 30 that includes holes 36 so that the wires 54 extend from the front side and an optional hole 36′ that exposes the resistive substrate 10. The plurality of attachment devices 40 that hold the power application portions (not shown) in place extends through the backing layer 30 and are visible.

FIG. 9E illustrates a thermistor 52 extending into the hole 36′ in the substrate and into contact with the substrate (not shown). The thermistor 52 is attached by conductors 58 that are bunched together with conductors 58 that are connected to wires 54 from the front side of the partial heater 4. The conductors 58 and wires 54 are connected together by electrical connectors 56.

FIG. 9F is a top view of a heater 2 with a patch 32 covering the wires, electrical connectors, and thermistor. The conductors 58 extend from out of the patch so that the conductors 58 can connect to a power source (now shown) and supply power to electrical components within the heater 2.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. About is intended to cover a listed number ±5%. Thus, “about 10” is intended to cover 9.5 to 10.5.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1) A heater comprising:
a. a resistive substrate that produces heat upon an application of power;
b. a substrate adhesive including a portion that extends into the resistive substrate and a portion that extends from one or more sides of the resistive substrate so that one side of the resistive substrate is free of the substrate adhesive and one or more sides is covered by a layer of the substrate adhesive;
c. one or more power application portions connected to the resistive substrate on the side of the resistive substrate that is free of the substrate adhesive;
d. one or more attachment devices that connect the one or more power application portions to the resistive substrate;
e. a closing layer including:
i. a closing backing and
ii. a backing adhesive that includes a portion that extends into the closing backing and a portion that extends from one or more sides of the closing backing so that one side of the closing backing is free of the backing adhesive and one or more sides is covered by a layer of the backing adhesive; and
wherein the closing layer extends over the one or more power application portions so that the backing adhesive covers the one or more power application portions, and
wherein the substrate adhesive and the backing adhesive extend together to form a single layer of adhesive.

2) The heater of claim 1, wherein the substrate adhesive, the backing adhesive, or both extend beyond one or more edges of the resistive substrate, one or more edges of the closing backing, or both respectively so that the substrate adhesive, the backing adhesive, or both form a partial peripheral edge or a full peripheral edge around the resistive substrate, the closing backing, or both respectively.

3) The heater of claim 1, wherein the substrate adhesive, the backing adhesive, or both extend beyond the one or more sides of the resistive substrate, the closing backing, or both respectively so that a thickness of the resistive substrate and substrate adhesive is greater than the thickness of only the resistive substrate and a thickness of the closing backing, the backing adhesive is greater than the thickness of only the closing backing, or both.

4) The heater of claim 1, wherein the attachment devices are sewing that penetrates and is connected to the resistive substrate, the substrate adhesive, or both.

5) The heater of claim 1, wherein a backing is connected to the one or more sides of the resistive substrate with a substrate adhesive and the one or more attachment devices extend through the resistive substrate, the substrate adhesive, and the backing.

6) The heater of claim 1, wherein the resistive substrate includes a hole and a thermistor extends into the hole to monitor conditions of the heater.

7) The heater of claim 1, wherein the one or more power application portions include:
a. one or more wires extending from the one or more power application portions that are connected to one or more conductors via one or more electrical connectors and the one or more wires, the electrical connectors, and the one or more power application portions are located on a surface of the resistive substrate;
b. one or more carbon nanotube yarns that are connected on the surface of the resistive substrate and connected to one or more conductors;
c. one or more graphite strips that are connected on the surface of the resistive substrate and connected to the one or more conductors; or
d. a combination of (a), (b), and (c).

8) The heater of claim 7, wherein a patch extends over the connection between the one or more power application portions and the one or more conductors, and the heater is free of a pocket that receives the connection between the one or more power application portions and the one or more conductors.

9) The heater of claim 7, wherein the resistive substrate and the substrate adhesive are slit into a plurality of strips after the substrate adhesive penetrates into the resistive substrate.

10) The heater of claim 9, wherein the plurality of strips are connected to a backing so that a gap is located between each of the plurality of strips.

11) The heater of claim 10, wherein one or more power application portions are connected to each of the plurality of strips and the one or more power application portions extend over the gaps to connect each of the plurality of strips.

12) A heater comprising:
a. a resistive substrate that produces heat upon an application of power;
b. one or more power application portions connected to the resistive substrate;
c. one or more attachment devices that connect the one or more power application portions to the resistive substrate;
d. a closing layer including:
i. a closing backing;
ii. a backing adhesive that extends over the one or more power application portions and connects the closing layer to the resistive substrate and the one or more power application portions;
iii. one or more holes that extend through the closing layer so that a portion of the resistive substrate is exposed through the hole; and
e. a thermistor;
wherein the thermistor, the one or more power application portions, or both extend through the one or more holes in the closing layer.

13) The heater of claim 12, wherein the thermistor extends through one of the one or more holes and proximate to or into contact with the resistive substrate so that the thermistor monitors a temperature of the heater.

14) The heater of claim 12, wherein wires that connect to the one or more power application portions and the thermistor are located on an external side of the heater.

15) The heater of claim 12, wherein the one or more power application portions extend through the one or more holes so that a portion of the one or more power application portions is located on an external side of the heater.

16) A method comprising:
a. applying a substrate adhesive to a resistive substrate that produces heat upon an application of power, and
b. preventing the substrate adhesive from fully penetrating through the resistive substrate so that the resistive substrate includes a side with the substrate adhesive and a side that is free of the substrate adhesive,
c. applying one or more power application portions over the side of the resistive substrate that is free of the substrate adhesive;
d. applying a closing layer over the one or more power application portions, the closing layer including:
i. a closing backing and
ii. a backing adhesive that includes a portion that extends into the closing backing and a portion that extends from one or more sides of the closing backing so that one side of the closing backing is free of the backing adhesive and one or more sides is covered by a layer of the backing adhesive;
e. laminating the closing layer and the resistive substrate so that the backing adhesive and the substrate adhesive connect and form one contiguous layer.

17) The method of claim 16, wherein the method includes a step of slitting the substrate adhesive and resistive substrate, after the substrate adhesive is applied to the resistive substrate, so that a plurality of strips are formed, and the method includes a step of laminating the plurality of strips to a backing so that gaps are located between each of the plurality of strips.

18) The method of claim 16, wherein the method includes a step of connecting one or more power application portions to the resistive substrate and extending the one or more power application portions over the gaps.

19) The method of claim 16, wherein the method includes a step of creating a hole in the closing layer and placing a thermistor in the hole.

20) The method of claim 16, wherein the backing and a backing layer are sealed so that a peripheral edge is formed around the resistive substrate, the thermistor, and the one or more power application portions.
